(19) United States
(12) Patent Application Publication
(10) Pub. No.: US 2011/0066745 A1
(43) Pub. Date: Mar. 17, 2011

(54) SHARING VIDEO STREAMS IN COMMNICATION SESSIONS

(75) Inventors: Stefan Olsson, Lund (SE); Jonas Andersson, Menlo Park, CA (US)

(73) Assignee: SONY ERICSSON MOBILE COMMUNICATIONS AB, Lund (SE)

(21) Appl. No.: 12/571,775

(22) Filed: Oct. 1, 2009

Related U.S. Application Data
(60) Provisional application No. 61/242,039, filed on Sep. 14, 2009.

(51) Int. Cl. G06F 15/16

(52) U.S. Cl. 709/231; 709/227

(57) ABSTRACT

A device may include a network interface, a display, and a processor. The network interface may be configured to send or receive one or more video streams. The display may be configured to show one or more video streams. The processor may be configured to start a session with a first remote device, send a first video stream to the first remote device, and send a request that instructs a network device to direct a second video stream from a second remote device to the first remote device and to stop sending the first video stream to the first remote device.

### BACKGROUND

When a device (e.g., a cellular phone) communicates with another device (e.g., another cellular phone), the devices may establish a session. In establishing the session, each device may allocate a portion of its dynamic memory to buffer communication data and track information (e.g., number of bytes received) that pertains to the session.

### SUMMARY

According to one aspect, a device may include a network interface to send or receive one or more video streams, a display to show one or more video streams, and a processor. The processor may be configured to start a session with a first remote device, send a first video stream to the first remote device, and send a request that instructs a network device to direct a second video stream from a second remote device to the first remote device and to stop sending the first video stream to the first remote device.

Additionally, the device may include one of a cellular telephone, a laptop, a personal computer, a personal digital assistant, a netbook, a gaming console, a digital camera, a video camera, a television, a set-top box, a digital video disk player, or an electronic notepad.

Additionally, the processor may be further configured to start a session with the second remote device, and receive the second video stream from the second remote device, Additionally, the display may be further configured to display the second video stream.

Additionally, before the processor sends the request, the processor may be further configured to at least one of: receive user input instructing the device to send the request; or determine whether the second video stream includes a particular image and generates the request when the second video stream includes the particular image.

Additionally, the network interface may be further configured to send information identifying a location and orientation of the device to the network device.

Additionally, the display may be further configured to display the first video stream.

Additionally, the network interface may be further configured to receive a third video stream from the first remote device and the display may be further configured to display the third video stream.

According to another aspect, a device may include a network interface to relay video streams and a processor. The processor may relay a first video stream from a first user device to a second user device, determine whether a second video stream from a third user device is to replace the first video stream, stop relaying the first video stream to the second user device when the processor determines that the second video stream is to replace the first video stream, and relay the second video stream in place of the first video stream to the second user device when the processor determines that the second video stream is to replace the first video stream.

Additionally, before the processor determines whether the second video stream from the third user device is to replace the first video stream, the network interface may be further configured to receive, from the first user device, a message that instructs the device to provide the second video stream to the second user device.

Additionally, when the processor is determining whether the second video stream from the third user device is to replace the first video stream, the processor may be further configured to determine whether the first user device is to subscribe to the second video stream based on at least one of: whether the first user device and the second user device are in close proximity of one another; whether the first user device and the second user device are similarly oriented; or whether the second video stream includes particular images.

Additionally, the processor may be further configured to determine a network path via which the first video stream is routed from the first user device to the second user device.

Additionally, the processor may be further configured to receive a message from the first user device to establish a session between the first user device and the second user device.

Additionally, the processor may be further configured to stop relaying the second video stream to the second user device up receiving a request from the first user device.

Additionally, when the processor is determining whether the second video stream from the third user device is to replace the first video stream, the processor may be further configured to receive an authorization from the second user device for the first user device to use the second video stream or determine whether the first user device is in a list of user devices that are authorized to use the second video stream.

According to yet another aspect, a method may include receiving at a first device a first video stream from a second device, sending a second video stream from the first device to a third device, determining whether the first device is to subscribe to the first video stream, stop sending the second video stream from the first device to the third device when it is determined that the first device is to subscribe to the first video stream, and sending the first video stream to the third device when it is determined that the first device is to subscribe to the first video stream.

Additionally, determining whether the first device is to subscribe to the first video stream may includes at least one of: determining whether the first device and the second device are located close to each other; determining whether the first device and the second device are similarly oriented; determining whether the first video stream includes particular images; determining whether first video stream and the second video stream include similar images; determining whether a processor in the first device is heavily loaded; or determining whether a user at the first device provides input to the first device to select the first video stream for subscription.

Additionally, the method may further include displaying the first video stream and the second video stream at the first device.

Additionally, determining whether the first device is to subscribe to the first video stream may include receiving an authorization from the second device for the first device to subscribe to the first video stream, or determining whether the first device is in a list of devices that are authorized to subscribe to the first video stream.

Additionally, the method may further include receiving a request from the second device to establish a session with the first device, and determining a network path by which the first video stream is relayed to the second device.

Additionally, the method may further include automatically initiating a session between the first device and the second device based on a friend list at the first device.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 illustrates concepts described herein;

FIG. 2 is a diagram of an exemplary network in which the concepts described herein may be implemented;

FIG. 3 is a diagram of an exemplary user device of FIG. 2;

FIG. 4 is a block diagram of components of an exemplary network device of FIG. 2;

FIG. 5 is a block diagram of exemplary functional components of the user device of FIG. 2;

FIG. 6 is a diagram of an exemplary graphical user interface (GUI) window of a communication application of the user device of FIG. 5;

FIG. 7 is a block diagram of exemplary functional components of a communication server device of FIG. 2;

FIG. 8 is a flow diagram of an exemplary process that is associated with the user device of FIG. 2;

FIG. 9 is a flow diagram of an exemplary process that is associated with the communication server device of FIG. 2;

FIG. 10 illustrates an example associated with sharing video streams in communication sessions.

### DETAILED DESCRIPTION

The following detailed description refers to the accompanying drawings. The same reference numbers in different drawings may identify the same or similar elements. As used herein, the term “multi-endpoint session” may refer to multiple, interrelated two-endpoint communication sessions. The term “multi-endpoint session” may also refer to a session in which multiple parties communicate with one another via a central point in the communication.

In the following, a first device that is communicating with a second device may subscribe to a video stream that is being sent from a third device to a fourth device. As a consequence of the subscription, the second device may receive the video stream from the third device over a network. The subscription may allow the second and fourth devices to not only share the video stream, but allow the network to avoid conveying an extraneous video stream from the first device, and, therefore, reduce network bandwidth utilization.

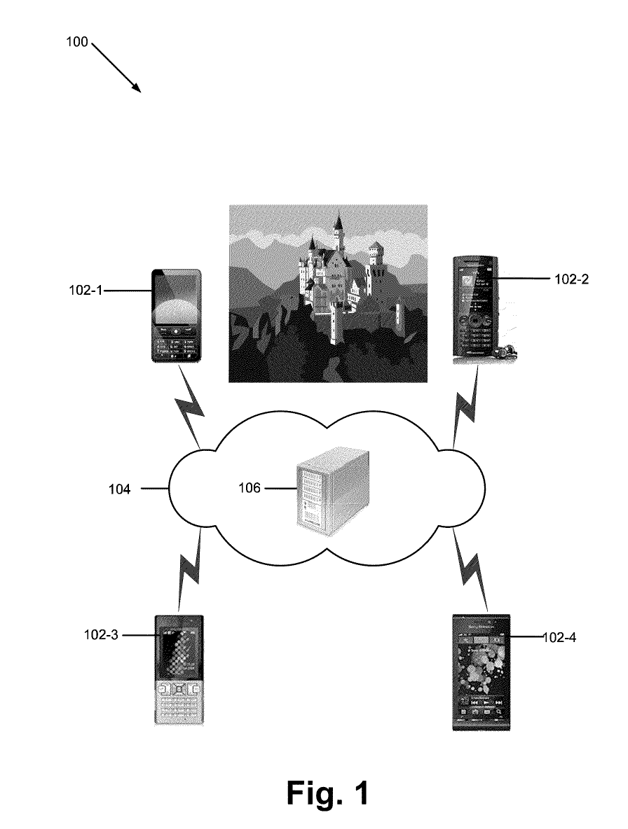

FIG. 1 illustrates an example of the above concept. As shown, a system 100 may include user devices 102-1 through 102-4, and network 104. Assume that user devices 102-1 and 102-2 are capable of capturing video images and transmitting the corresponding video streams to user devices 102-3 and 102-4, respectively, via a communication application installed on each of user devices 102-1 through 102-4. In addition, assume that users of user devices 102-1 and 102-2 are visiting the Neuschwanstein castle in Germany, and that each of the users are capturing videos of Neuschwanstein castle for transmission to user devices 102-3 and 102-4, respectively.

When user devices 102-1 and 102-2 transmit video streams, network 104 may receive the video streams from user devices 102-1 and 102-2 via one or more wireless access points (not shown) and route the video streams to a server device, shown as communication server device 106. Depending on information received from user devices 102-1 and 102-2, communication server device 106 may cause user device 102-3 to receive the video stream that is sent from user device 102-2 to user device 102-4, which may be a better quality video stream than the video stream from user device 102-1. Consequently, both user devices 102-3 and 102-4 may receive the video stream from user device 102-2. Further, network 104 may prevent the video stream from user device 102-1 from being delivered to user device 102-3, thereby saving network bandwidth.

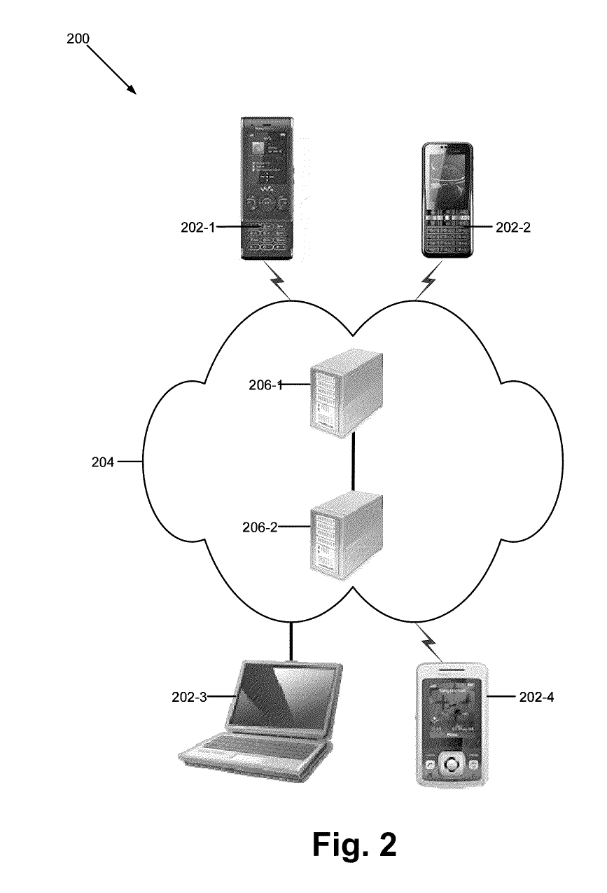

FIG. 2 is a diagram of an exemplary network 200 in which the concepts described herein may be implemented. As shown, network 200 may include user devices 202-1 through 202-4 (collectively referred to as user devices 202 and individually as user device 202-x), network 204, and communication server devices 206-1 and 206-2 (collecively referred to as communication server devices 206 and individually as communication server device 206-x). Although not shown, network 200 may include other devices, such as wireless access points (WAPs), routers, switches, etc. Further, depending on the implementation, network 200 may include additional, fewer, or different devices than the ones illustrated in FIG. 2. For example, in some implementations, network 200 may include hundreds, thousands, or more of user devices 202.

User device 202-x may transmit and/or receive a video stream. Further, in sending or receiving the video stream, user device 202-x may send additional information that permits a device that routes the video stream to optimize and/or reduce the amount of data that is sent from user device 202-x over network 204.

For example, assume that user device 202-1 establishes a communication session with user device 202-3, and sends additional information that indicates, to devices that establish the communication link between user devices 202-1 and 202-3 that a video stream from user device 202-1 can be substituted with that transmitted from user device 202-2. In such an instance, the devices that establish the communication link may send the video stream from user device 202-2 to user device 202-3 in place of the video stream from user device 202-1.

User device 202-x may be capable of other functions, such as Internet Protocol (IP) communications (e.g., text messaging, emailing, instant messaging, etc.), placing a telephone call, running a variety of applications (e.g., a word processor, a game, etc.), etc.

Network 204 may include a fiber-optic network (e.g., passive optical networks (PONs)), an ad hoc network, a local area network (LAN), a wide area network (WAN), a wireless LAN, a metropolitan area network (MAN), a cellular network, a public switched telephone network (PSTN), an intranet, the Internet, a satellite-based network, any other network, or a combination of networks. Devices that are shown in FIG. 2 may connect to network 204 via wireless, wired, or optical communication links. In addition, network 204 may allow any of devices 202-1 through 202-4, 206-1, and 206-2 to communicate with any of other devices 202-1 through 202-4, 206-1 and 206-2.

Communication server device 206-x may provide a point via which video streams from user devices 202 are routed to another communication server device 206-x that may distribute the video streams to user devices 202.

In allowing user devices 202 to communicate with one another, communication server device 206-x may establish a multi-endpoint communication session for user devices 202. Further, in response to signaling from user device 202-x (e.g., user device 202-2), communication server device 206-x may allow user device 202-x (e.g., user device 202-2) to join the session and/or leave the session, and control sharing of video streams between different user devices 202. By allowing user devices 202 to share the video streams, communication server device 206 may reduce bandwidth utilization in network 204.

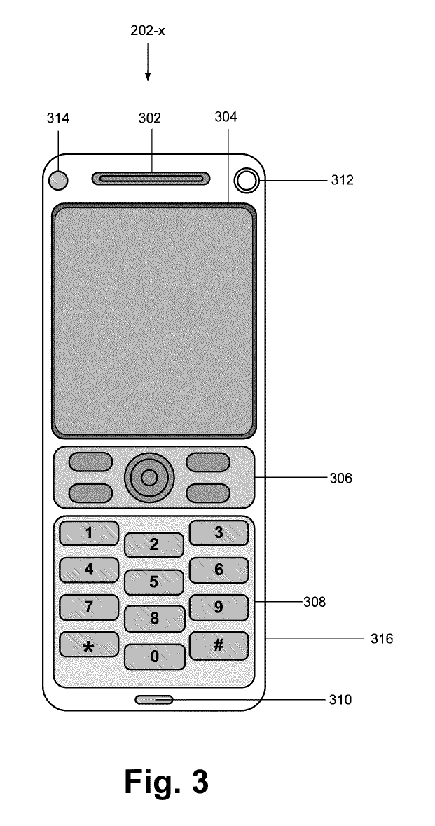

FIG. 3 is a diagram of an exemplary user device 202-x. User device 202-x may include any of the following devices: a mobile telephone; a cellular phone; a personal communications system (PCS) terminal that may combine a cellular radiotelephone with data processing, facsimile, and/or data communications capabilities; an electronic notepad, a laptop, a netbook, an ultra mobile personal computer (UMPC), and/or a personal computer; a personal digital assistant (PDA) that can include a telephone; a gaming device or console; a peripheral (e.g., wireless headphone); a digital camera; or another type of computational or communication device.

In this implementation, user device 202-x may take the form of a mobile phone (e.g., a cell phone). As shown in FIG. 3, user device 202-x may include a speaker 302, a display 304, control buttons 306, a keypad 308, a microphone 310, sensors 312, a front camera 314, and a housing 316.

Speaker 302 may provide audible information to a user of user device 202-x. Display 304 may provide visual information to the user, such as an image of a caller, video images, or pictures. In addition, display 304 may include a touch screen for providing input to user device 202-x. Control buttons 306 may permit the user to interact with user device 202-x to cause user device 202-x to perform one or more operations, such as place or receive a telephone call. Keypad 308 may include a telephone keypad. Microphone 310 may receive audible information from the user. Sensors 312 may collect and provide, to user device 202-x, information (e.g., acoustic, infrared, etc.) that is used to aid the user in capturing images or in providing other types of information (e.g., a distance between a user and user device 202-x). Front camera 314 may enable a user to view, capture and store images (e.g., pictures, videos) of a subject in front of user device 202-x. Housing 316 may provide a casing for components of user device 202-x and may protect the components from outside elements.

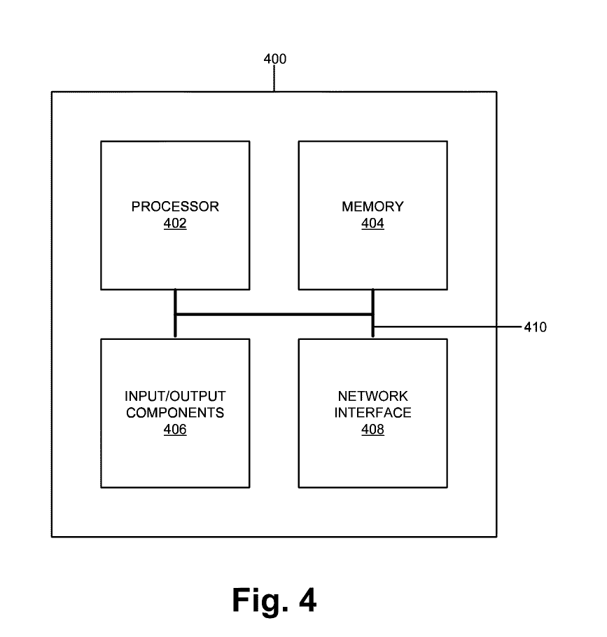

FIG. 4 is a block diagram of a network device 400, which may represent any of user devices 202 and communication server devices 206. As shown in FIG. 4, network device 400 may include a processor 402, a memory 404, input/output components 406, a network interface 408, and a communication path 410. In different implementations, device 400 may include additional, fewer, or different components than the ones illustrated in FIG. 4. For example, device 400 may include additional network interfaces, such as interfaces for receiving and sending data packets.

Processor 402 may include a processor, a microprocessor, an Application Specific Integrated Circuit (ASIC), a Field Programmable Gate Array (FPGA), and/or other processing logic (e.g., audio/video processor) capable of processing information and/or controlling network device 400. Memory 404 may include static memory, such as read only memory (ROM), and/or dynamic memory, such as random access memory (RAM), or onboard cache, for storing data and machine-readable instructions. Memory 404 may also include storage devices, such as a floppy disk, CD ROM, CD read/write (R/W) disc, and/or flash memory, as well as other types of storage devices.

Input/output components 406 may include a display screen (e.g., display 304, etc.), a keyboard, a mouse, a speaker, a microphone, a Digital Video Disk (DVD) writer, a DVD reader, Universal Serial Bus (USB) lines, and/or other types of components for converting physical events or phenomena to and/or from digital signals that pertain to network device 400. In some implementations, input/output components 406 may also include position/movement/orientation detecting components, such as an electronic gyroscope or an accelerometer.

Network interface 408 may include any transceiver-like mechanism that enables network device 400 to communicate with other devices and/or systems. For example, network interface 408 may include mechanisms for communicating via a network, such as the Internet, a terrestrial wireless network (e.g., a WLAN), a cellular network, a satellite-based network, a wireless personal area network (WPAN), etc. Additionally or alternatively, network interface 408 may include a modem, an Ethernet interface to a LAN, and/or an interface/connection for connecting network device 400 to other devices (e.g., a Bluetooth interface).

Communication path 410 may provide an interface through which components of network device 400 can communicate with one another.

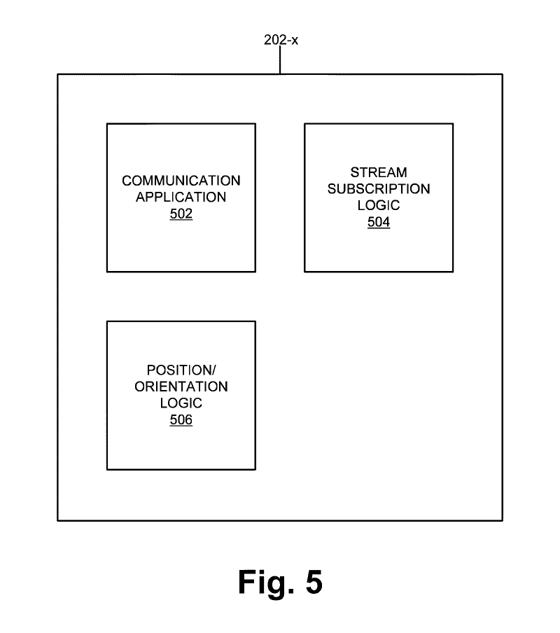

FIG. 5 is a block diagram of exemplary functional components of user device 202-x. As shown, user device 202-x may include communication application 502, stream subscription logic 504, and/or position/orientation logic 506. Depending on the implementation, user device 202-x may include additional, fewer, or different functional components than those illustrated in FIG. 5. For example, user device 202-x may include an operating system, document application, game application, etc.

Communication application 502 may include an application (e.g., a browser, a stand-alone application, etc.) for sending and/or receiving video streams to/from user device 202-x. Via communication application 502, a user of user device 202-x may initiate or join a multi-endpoint communication session.

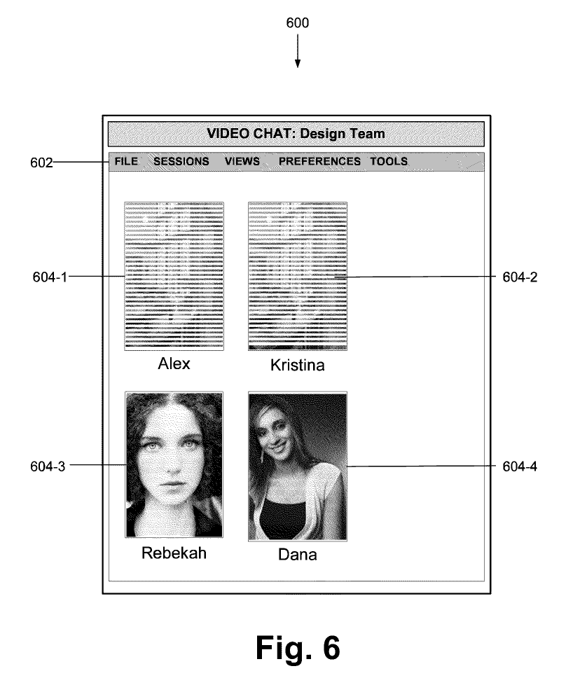

FIG. 6 is a diagram of an exemplary graphical user interface (GUI) window 600 of communication application 502. As shown, GUI window 600 may include a menu 602 and video session windows 604-1 through 604-4 (collectively referred to as video session windows 604 and individually as video session window 604-x). Depending on the implementation, GUI window 600 may include additional, fewer, or different components than those illustrated in FIG. 6.

Menu 602 may allow a user to conduct a multi-endpoint session (e.g., start a session and/or an end a session). For example, in one implementation, the user may navigate through a menu tree via menu 602 to initiate a multi-endpoint session based on a list of friends of the user.

In addition, menu 602 may allow the user to perform operations that are associated with a session. The operations may include, for example, saving a session in the form of video streams to one or more files, replaying a saved session, editing a saved session, modifying parameters that are associated with a current or future session (e.g., a list of friends that may participate in a session), controlling arrangements or properties of video session windows 604 (e.g., contrast or brightness), modifying preferences (e.g., whether an audio may be automatically enabled for a specific video session window 604-x or all video session windows 604), creating a list of users that may subscribe to a video stream from user device 202-x), etc.

Video session window 604-x may display a video stream from user device 202-x. For example, assume that Alex, Kristina, Rebekah, and Dana are users of user devices 202-1, 202-2, 202-3, and 202-4, respectively. Each of video session windows 604 may show a video stream from one of user devices 202.

Returning to FIG. 5, stream subscription logic 504 may subscribe communication application 502 to a video stream from another user device 202-x. Continuing with the above example, assume that Alex has Kristina's permission to subscribe to her video stream. To subscribe to the video stream from Kristina's device (e.g., user device 202-2), Alex user may use input/output components 406 (e.g., touch screen) to drag-and-drop video session window 604-2 onto video session window 604-1. In a different implementation, Alex may initiate the subscription by navigating through a menu tree via menu 602.

Upon receiving user input from Alex, communication application 502 may interact with network devices that route video streams to allow the video stream from user device 202-2 to be delivered to user device 202-3 in place of Alex's video stream.

Consequently, user devices 202-3 and 202-4 may receive the video stream from user device 202-2 instead of user device 202-1. This may allow a user to select a video stream or multi-media stream that is better in quality (e.g., higher resolution, unobstructed viewing angle, better audio, etc.). As shown in FIG. 5, to indicate that user device 202-1 is subscribed to user device 202-2's video stream, communication application 502 may display user device 202-2's video stream in video session window 604-1 as well as in video session window 604-2.

In some implementations, stream subscription logic 504 may cause communication application 502 to automatically subscribe to a video stream from another user device 202-x when the operating conditions of user device 202-x meet particular criteria. For example, assume that user devices 202 are continually exchanging data that pertain to physical location and orientation of each of user devices 202, and user device 202-1 is approximately 50 feet away from user device 202-2. When user device 202-1 and user device 202-2 are pointing in approximately the same directions, stream subscription logic 504 of user device 202-1 may conclude that the user device 202-1 and user device 202-2 are capturing similar images (e.g., the same building, natural wonder such as the Grand Canyon, etc.), and automatically subscribe communication application 502 of user device 202-1 to the video stream from user device 202-2.

Depending on the implementation, stream subscription logic 504 may use different criteria for determining whether communication application 502 in user device 202-x may subscribe to a video stream from another user device 202-x. The criteria may include, for example, whether two user devices 202 are positioned in close proximity to one another and/or similarly oriented (e.g., facing approximately the same direction); whether two user devices 202-x have each other's permission to share the video streams, whether a user of one user device 202-x has explicitly subscribed to the video stream of another user device 202-x, whether two user devices 202 are sending video streams whose images are similar (e.g., filming the same concert), etc.

Position/orientation logic 506 may include hardware and/or software components for determining physical location and orientation of user device 202-x. Stream subscription logic 504 of user device 202-x may use position/orientation logic 506 of user device 202-x to determine whether communication application 502 of user device 202-x may subscribe to a video stream from another user device 202-x.

In FIG. 5, user device 202-x is illustrated as including stream subscription logic 504. In other implementations, part or all of the logic for subscribing to a video stream from another device may be included in a different device (e.g., a communication server device 206-x). In such implementations, user device 202-x may not include stream subscription logic 504.

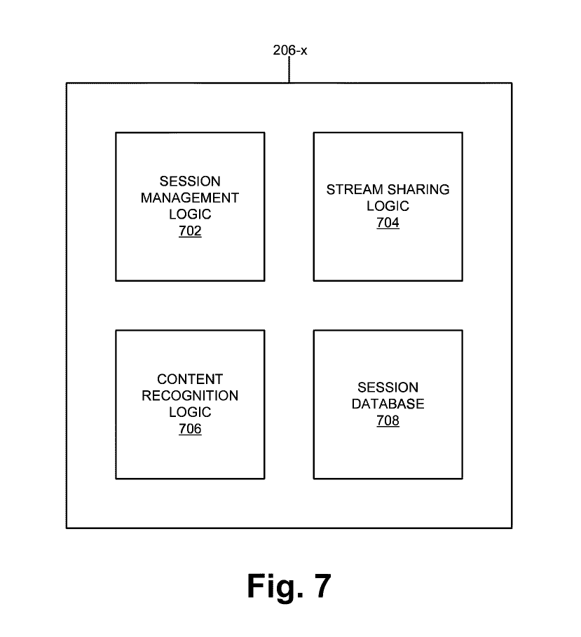

FIG. 7 is a block diagram of exemplary functional components of a communication server device 206-x. As shown, communication server device 206-x may include session management logic 702, stream sharing logic 704, content recognition logic 706, and session database 708. Depending on the implementation, communication server device 206-x may include additional, fewer, or different functional components than those illustrated in FIG. 7. For example, communication server device 206-x may include an operating system, web server, firewall, etc.

Session management logic 702 may receive requests to start a communication session from user devices 202, exchange command signals with other command server devices 206 to establish or tear down paths for conveying video traffic, and route video traffic through the paths. In addition, session management logic 702 may allow communication application 502 of user device 202-x to join or leave a session. Further, session management logic 702 may determine, via stream sharing logic 704, whether communication application 502 may subscribe to or unsubscribe from a video stream.

Stream sharing logic 704 may include similar logic as stream subscription logic 504 of user device 202-x, and may determine whether user device 202-x may subscribe to a video stream based on criteria and notify session management logic 702 of the determination. When communication application 502 of user device 202-x is engaged in a session, communication application 502 may continuously provide information (e.g., user device 202-x status such as processor load, the position/orientation of user device 202-x, etc.) to session management logic 703, which may relay the information to stream sharing logic 704. In turn, stream sharing logic 704 may use the information to determine whether user device 202-x may subscribe to a video stream.

Depending on the implementation, stream sharing logic 704 may use different criteria for determining whether user device 202-x may subscribe to a video stream. In some implementations, however, the criteria may exclude ones that stream subscription logic 504 of user device 202-x uses to determine whether user device 202-x may subscribe to a video stream. This may allow stream sharing logic 704 of communication server device 206-x and stream subscription logic 504 of user device 202-x to avoid performing overlapping functions.

Examples of the criteria for sharing a video stream may include whether two user devices 202 are positioned in close proximity to one another and/or are similarly oriented; whether two user devices 202 have each other's permission to share the video streams; whether a user of one user device 202-x has explicitly subscribed to the video stream of another user device 202-x; whether two user devices 202 are sending video streams whose images are similar; whether one video stream to which user device 202-x may subscribe is of better quality (e.g., higher resolution, less shaky, etc.) than other video streams, etc.

In yet another example, stream sharing logic 704 may determine whether a video stream may be shared based on voting from user devices 202 that receive different video streams. The votes may indicate the quality of the video stream. For example, video streams whose images are tilted (e.g., due to orientation of the camera) and or shaky may be voted down, and those video streams may not be subscribed by many users. Over time, the users may choose the best available video stream.

Content recognition logic 706 may include hardware and/or software components for comparing content (e.g., images) of one video stream to that of another video stream. In some implementations, stream sharing logic 704 may use content recognition logic 706 to resolve whether a video stream from one user device 202-x is similar to a video stream from another user device 202-x. Based on the degree of similarity, stream sharing logic 704 may subscribe communication application 502 on user device 202-x to a video stream from another user device 202-x.

Session database 708 may include records that pertain to each communication application 502 on user devices 202. For example, session database 708 may include a list of user devices 202 that may subscribe to a video stream from user device 202-x. In another example, session database 708 may include friend lists (e.g., a list of user devices 202 that may send video streams to user device 202-x), user information that is accessible to user devices 202 in a friend list (e.g., contact information, calendar, etc.), user preferences, etc.

### Exemplary Processes for Advertisement Reimbursements

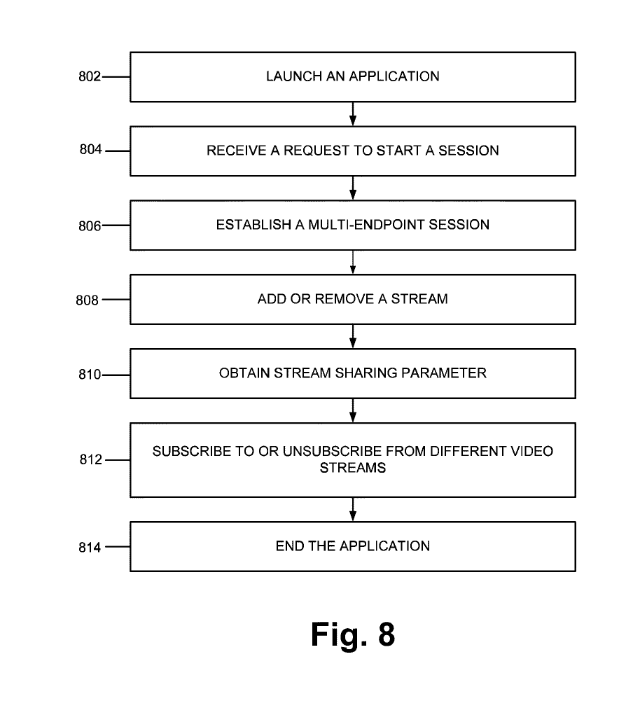

FIG. 8 is a flow diagram of an exemplary process 800 that is associated with user device 202-x. Process 800 may begin with launching or starting communication application 502 in user device 202-x (block 802). For example, a user may launch communication application 502 by activating a menu item. In another example, communication application 502 may be launched automatically when user device 202-x is powered on.

Communication application 502 may receive a request to start a communication session (block 804). In some situations, communication application 502 may receive the request from a user via a GUI component. In other situations, communication application 502 may receive the request from another communication application 502 that is hosted on remote user device 202-y.

Communication application 502 may establish a multi-endpoint session (block 806). To establish the session, communication application 502 of user device 202-x may send a request to establish a communication session with remote user device 202-y to communication server device 206-x. Communication server device 206-x may interact with other communication server devices 206 and/or communication application 502 on remote user device 202-y to establish the session. When communication application 502 of user device 202-x establishes the session with remote user device 202-y, communication application 502 may send a video stream (e.g., from a camera) to remote user device 202-y.

Communication application 502 may add or remove a video stream (block 808). For example, in FIG. 6, GUI window 600 of communication application 502 displays four video streams, each video stream corresponding to video session window 604-x. When communication application 502 receives Alex's input to discontinue receiving the video stream from Kristina, communication application 502 may remove the video stream from the communication session. Removing the video stream from the session may also remove video session window 604-2 from GUI window 600. When communication application 502 receives a request to establish a communication link from remote user device 202-y, communication application 502 may accept the request upon receiving Alex's permission and add a video stream from remote user device 202-y to the session. Consequently, a new video session window that corresponds to the added video stream may be created within GUI window 600.

Communication application 502 and/or stream subscription logic 504 may obtain stream sharing parameters (block 810). As used herein, the term “stream sharing parameters” may refer to data or information that may be used to determine whether communication application 502 may subscribe to a video stream. Depending on the situation and/or operating conditions, stream sharing parameters may be obtained from a user via a GUI component (e.g., a user request to subscribe to another stream). Alternatively, communication application 502 and/or stream subscription logic 504 may obtain the stream sharing parameters from another component (e.g., position/orientation logic 506).

Communication application 502 and/or stream subscription logic 504 may subscribe to or unsubscribe from different video streams (block 812). For example, assume that user device 202-1 establishes one or more communication sessions with user devices 202-2 and 202-3, and indicates, to communication server device 206-1 that a video stream from user device 202-2 can be substituted with a video stream from user device 202-1. Consequently, communication server device 206-1 may send the video stream from user device 202-2 in place of the video stream from user device 202-1 to user device 202-3.

During the session, stream subscription logic 504 may continually subscribe to and/or unsubscribe from different video streams, depending on user input and/or operating status/conditions of user device 202-x. For instance, the user of user device 202-x may request, via a GUI window, communication application 502 to subscribe to or unsubscribe from to a video stream. In another example, communication application 502 may be configured to subscribe to a video stream that includes specific images (e.g., an image of a building). For example, when stream subscription logic 504 in user device 202-1 detects an image of a particular building in a video stream from user device 202-2, stream subscription logic 504 in user device 202-1 may subscribe to the video stream.

Communication application 502 may terminate (block 814). Upon receiving a shutdown command from the user or from another component/application (e.g., the operating system) in user device 202-x, communication application 502 may terminate.

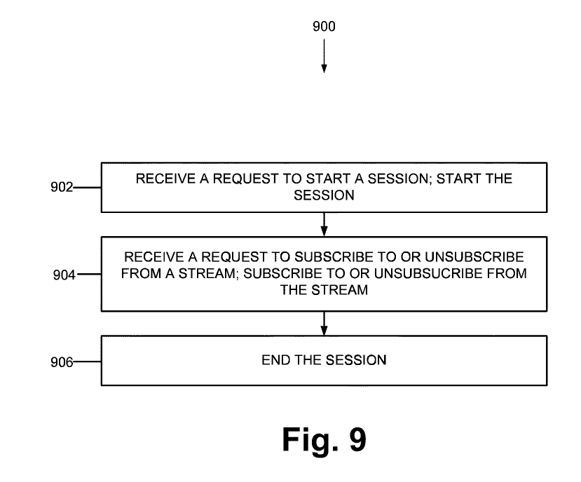

FIG. 9 is a flow diagram of an exemplary process 900 that is associated with communication server device 206-x. Process 900 may start with session management logic 702 in communication server device 206-x receiving a request from user device 202-x to start a communication session (block 902). The request may identify one or more user devices 202 with which user device 202-x may exchange video streams.

Session management logic 702 may start the session (block 902). In some implementations, starting the session may entail exchanging messages with session management logic 702 in other communication server devices 206 to establish paths for video streams. In other implementations, the video streams may be dynamically routed based on user device addresses that are provided with the video streams. The session may start once the endpoints and/or paths of communication are established. Subsequently, user device 202-x may send or receive video streams from other user devices 202.

Session management logic 702 may receive a request to subscribe to or unsubscribe from a video stream (block 904). During the session, user device 202-x may send a request to subscribe to one of the video streams in the session to session management logic 702 in communication server device 206-x. When session management logic 702 receives the request from user device 202-x, session management logic 702 may substitute a video stream from another user device 202-x to transmit to user devices 202 in place of the video stream from user device 202-x.

In one implementation, when session management logic 702 receives the request, session management logic 702 may distribute information to other communication server devices 206 to establish paths from a source (e.g., a user device) of the subscribed video stream to user devices 202 that are communicating with user device 202-x. The subscribed video stream may then be routed to user devices 202.

In a different implementation, upon receiving the request from user device 202-x, session management logic 702 may cause communication server device 206-x that is relaying the subscribed video stream to tag the subscribed video stream with addresses of user devices 202 that are receiving a video stream from user device 202-x. In such an instance, the subscribed video stream may be delivered to the user devices 202 via communication server devices 206 in accordance with the tagged addresses.

In some implementations, session management logic 702 may receive the request to subscribe to the video stream from stream sharing logic 704. Based on information from user device 202-x, stream sharing logic 704 in communication server device 206-x may determine whether user device 202-x may subscribe to a video stream. Based on the determination, stream sharing logic 702 may request session management logic 702 to subscribe to the video stream.

For example, in one implementation, stream sharing logic 704 may automatically determine whether a video stream from one user device 202-x is similar to a video stream from another user device 202-x that can transmit a video with higher resolution. In such an instance, stream sharing logic 704 may request session management logic 702 to subscribe the one user device 202-x to the other user device 202-x.

In another example, stream sharing logic 704 may determine whether a video stream contains particular images (e.g., images that a user of user device 202-x likes), and if so, may generate the request. In another example, stream sharing logic 704 may determine whether user device 202-x is under heavy processing/communication load, and generate the request for video subscription if the load is greater than a predetermined threshold. In yet another example, stream sharing logic 704 may determine whether a first user device 202-x is in a similar location/orientation as a second user device 202-x. If the physical locations are close and the orientations are similar, the first user device 202-x may subscribe to a video stream from the second user device 202-x.

Session management logic 702 may end the session (block 906). In one implementation, when session management logic 702 receives a message from user device 202-x to terminate the session, session management logic 702 may send notifications to user devices 202 sending/receiving video streams to/from user device 202-x that user device 202-x is closing the communication sessop. In response, communication application 502 in each of user devices 202 may perform bookkeeping activities that are associated with terminating the session with user device 202-x (e.g., closing down a socket). Thereafter, communication server device 206-x may terminate the session.

In other implementations, user device 202-x may directly send the notifications to end the session to other user devices 202 and communication server device 206-x. In such an instance, communication server device 206-x may simply terminate the session without notifying other user devices 202.

### EXAMPLE

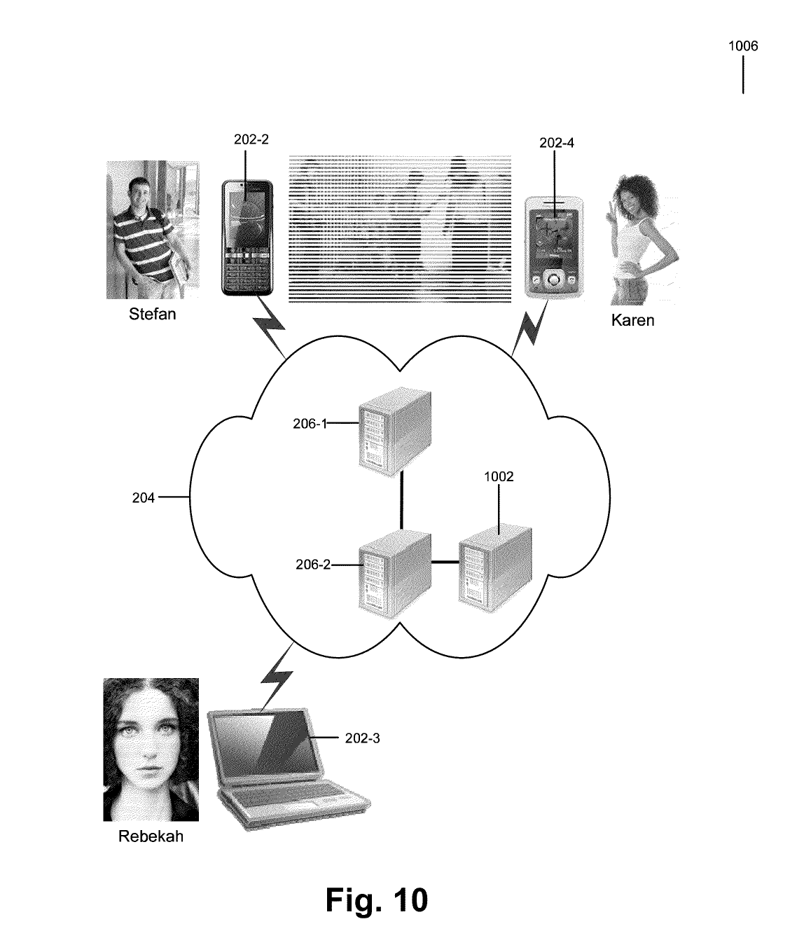

FIG. 10 illustrates an example that is associated with sharing video streams in communication sessions. The example is consistent with the above descriptions. Assume that Stefan and Karen are attending the same concert. Assume also that Stefan and Karen are sitting at two different locations. Further, assume that Stefan and Karen wish to send videos of the concert to a blog site on a server device 1002 in network 204 and to Rebekah's user device 202-3, respectively. Also, assume that Stefan and Karen own cell phones 202-2 and 202-4, respectively.

When Stefan contacts the blog site at server device 1002, communication server devices 206 set up a session between user device 202-2 and server device 1002. Similarly, when Karen calls Rebekah, communication server devices 206 set up a session between user device 202-4 and 202-3.

While blogging, Stefan discovers that Karen, who is on Stefan's friend list, is at the concert. Stefan initiates another session with Karen via communication server device 206-1, and exchanges video streams with Karen.

Stefan notices that Karen's video stream shows a better view of the concert, and decides to subscribe to Karen's video stream. Via a GUI component of communication application 502 on user device 202-2, Stefan activates an icon associated with Karen. The activation causes user device 202-2 to subscribe to Karen's video stream (e.g., the video stream from user device 202-4).

When user device 202-2 subscribes to the video stream from Karen, communication server devices 206 stop delivering Stefan's video stream (e.g., the video stream from user device 202-2) to Karen and to server device 1002. In addition, communication server devices 206 send the video stream from Karen (i.e., device 202-4) to the blog site at server device 1002 in place of the video stream from Stefan (i.e., device 202-2).

As a consequence of the subscription, Stefan is able to upload a better video of the concert to server device 1002. Furthermore, the subscription allows communication server devices 206 to reduce network traffic by not delivering the video stream from user device 202-2 to server device 1002 and to user device 202-4.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

For example, in some implementations, communication application 502 may allow users to select an overall “permit/allow” feature to allow a third party video streams to be used when those streams of higher quality. In such implementations, the third party may or may not be in a friend list. In another example, in some implementations, multimedia streams or audio streams may be shared in a manner similar to the ones described above based on criteria that pertain to audio quality (e.g., in situations where a user is taping a concert, speech, etc.).

In addition, while series of blocks have been described with regard to the exemplary processes illustrated in FIGS. 8 and 9, the order of the blocks may be modified in other implementations. In addition, non-dependent blocks may represent acts that can be performed in parallel to other blocks. Further, depending on the implementation of functional components, some of the blocks may be omitted (e.g., block 808 from process 800).

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A device comprising:
a network interface to send or receive one or more video streams;
a display to show one or more video streams; and
a processor to:
start a session with a first remote device;
send a first video stream to the first remote device; and
send a request that instructs a network device to direct a second video stream from a second remote device to the first remote device and to stop sending the first video stream to the first remote device.

2. The device of claim 1, wherein the device comprises one of: a cellular telephone, a laptop, a personal computer, a personal digital assistant, a netbook, a gaming console, a digital camera, a video camera, a television, a set-top box, a digital video disk player, or an electronic notepad.

3. The device of claim 1, wherein the processor is further configured to:
start a session with the second remote device, and
receive the second video stream from the second remote device; and wherein the display is further configured to:
display the second video stream.

4. The device of claim 3, wherein before the processor sends the request, the processor is further configured to at least one of:
receive user input instructing the device to send the request; or
determine whether the second video stream includes a particular image and generates the request when the second video stream includes the particular image.

5. The device of claim 1, wherein the network interface is further configured to send information identifying a location and orientation of the device to the network device.

6. The device of claim 1, wherein the display is further configured to:
display the first video stream.

7. The device of claim 1, wherein the network interface is further configured to receive a third video stream from the first remote device and wherein the display is further configured to display the third video stream.

8. A device comprising:
a network interface to relay video streams; and
a processor to:
relay a first video stream from a first user device to a second user device,
determine whether a second video stream from a third user device is to replace the first video stream;
stop relaying the first video stream to the second user device when the processor determines that the second video stream is to replace the first video stream, and
relay the second video stream in place of the first video stream to the second user device when the processor determines that the second video stream is to replace the first video stream.

9. The device of claim 8, wherein before the processor determines whether the second video stream from the third user device is to replace the first video stream, the network interface is further configured to:
receive, from the first user device, a message that instructs the device to provide the second video stream to the second user device.

10. The device of claim 8, wherein when the processor is determining whether the second video stream from the third user device is to replace the first video stream, the processor is further configured to determine whether the first user device is to subscribe to the second video stream based on at least one of:
whether the first user device and the second user device are in close proximity of one another;
whether the first user device and the second user device are similarly oriented; or
whether the second video stream includes particular images.

11. The device of claim 8, wherein the processor is further configured to:
determine a network path via which the first video stream is routed from the first user device to the second user device.

12. The device of claim 8, wherein the processor is further configured to:
receive a message from the first user device to establish a session between the first user device and the second user device.

13. The device of claim 8, wherein the processor is further configured to:
stop relaying the second video stream to the second user device up receiving a request from the first user device.

14. The device of claim 8, wherein when the processor is determining whether the second video stream from the third user device is to replace the first video stream, the processor is further configured to:
receive an authorization from the second user device for the first user device to use the second video stream; or
determine whether the first user device is in a list of user devices that are authorized to use the second video stream.

15. A method comprising:
receiving at a first device a first video stream from a second device;
sending a second video stream from the first device to a third device;
determining whether the first device is to subscribe to the first video stream;
stop sending the second video stream from the first device to the third device when it is determined that the first device is to subscribe to the first video stream; and
sending he first video stream to the third device when it is determined that the first device is to subscribe to the first video stream.

16. The method of claim 15, wherein determining whether the first device is to subscribe to the first video stream includes at least one of:
determining whether the first device and the second device are located close to each other;
determining whether the first device and the second device are similarly oriented;
determining whether the first video stream includes particular images;
determining whether first video stream and the second video stream include similar images;
determining whether a processor in the first device is heavily loaded; or
determining whether a user at the first device provides input to the first device to select the first video stream for subscription.

17. The method of claim 15, further comprising:
displaying the first video stream and the second video stream at the first device.

18. The method of claim 15, wherein determining whether the first device is to subscribe to the first video stream includes:
receiving an authorization from the second device for the first device to subscribe to the first video stream; or
determining whether the first device is in a list of devices that are authorized to subscribe to the first video stream.

19. The method of claim 15, further comprising:
receiving a request from the second device to establish a session with the first device; and
determining a network path by which the first video stream is relayed to the second device.

20. The method of claim 15, further comprising:
automatically initiating a session between the first device and the second device based on a friend list at the first device.
